(19) United States
(12) Patent Application Publication
(10) Pub. No.: US 2003/0053404 A1
(43) Pub. Date: Mar. 20, 2003

(54) Information recording medium

(76) Inventor: Tetsuya Kondo, Yokohama (JP)

Correspondence Address: Morris Liss, Connolly Bove Lodge & Hutz LLP, Suite 800, 1990 M Street, N.W., Washington, DC, 20036-3425, US

(21) Appl. No.: 10/102,023

(22) Filed: Mar. 21, 2002

(30) Foreign Application Priority Data
Mar. 22, 2001 (JP) 2001-082278
Feb. 19, 2002 (JP) 2001-041250

(51) Int. Cl. G11B 7/26

(52) U.S. Cl. 369/275.4; 369/284; 369/275.1; 430/270.13; 430/945

(57) ABSTRACT

An information recording medium including a substrate having a tiny pattern of serial groove portion and land portion alternately formed in parallel, a recording layer composed of recording material formed on the tiny pattern of the substrate, and a transparent layer formed on the recording layer, having the thickness of 0.05 to 0.4 mm, wherein the tiny pattern is formed under condition of P≦λ/NA that P is a pitch of the groove portion and the land portion, λ is a wavelength of a laser light for reproducing information from the information recording medium, NA is a numerical aperture of an objective lens for outputting the laser light for reproducing information from the information recording medium, and a reference clock is recorded windingly in the land portion as a sine waveform.

### BACKGROUND OF THE INVENTION

1. Field of Invention

The present invention relates to an information recording medium for use in a reproducing apparatus which reproduces information by a relative movement of such the information recording medium, and particularly, for recording and/or reproducing information by optical device.

2. Description of Related Art

There provided a system for reproducing information from an information recording medium by making a relative movement of the information recording medium using an optical device, a magnetic device or an electric capacitance device.

Particularly, a system utilizing the optical device to record and/or reproduce information is widely used in our daily life. For example, a disciform information recording medium for play-back only, utilizing a light having wavelength of 650 nm, such as DVD video disk for video information, DVD-ROM disk for program, DVD audio disk and SACD for audio information is known to wide public.

In addition, there are disciform information recording mediums for recording and reproducing information such as DVD-RAM disk and DVD+RW disk utilizing phase change technology, and ASMO disk and iD (intelligent image disk) utilizing photo-magnetism technology.

In the meantime, a violaceous laser having a short wavelength to increase storage density of the information recording medium has been studied for a long time. Recently invented device for having second harmonic generating element or a gallium nitride semi-conductor laser (disclosed in Japanese Patent No. 2778405) can provide laser having the wavelength λ within the range of 350 to 450 nm, which also can provide higher recording density. Further, the design of an objective lens for such the laser has improved recently. Especially, a lens having a numerical aperture (NA) of 0.7, which is higher than the lens for DVD (having NA of 0.6), is under development.

A system for using a laser of which wavelength is within a range of 350 to 450 nm and a objective lens of which NA is more than or equal to 0.7 is under development. It is expected that these technologies provide an optical disc system having more storage density compare to DVD disk. Further, it is expected that there provides highly advanced information recording medium having higher storage density, designed for use in a system utilizing violaceous laser and high NA objective lens.

A recent disciform information recording medium for recording and reproducing information has a minute track structure so called land-groove type. FIG. 14 is a cross-sectional view of an information recording medium of the land-groove type. FIG. 15 is an enlarged partial plan view of the information recording medium shown in FIG. 14.

In FIG. 14, an information recording medium 100 is composed of a recording layer 120 and a transparent layer 110 serially laminated on a substrate 130. A tiny pattern 200 is formed on the substrate with land portions L0 and groove portions G0.

Upon recording, as shown in FIG. 15, a record mark M is formed in both the land portions L0 and the groove portions G0.

In FIG. 15, a pitch P is the shortest distance from one groove portion to the next adjacent groove portion. In this sense, the shortest distance from a land portion to the next adjacent land portion is also pitch P. A laser light beam not shown is radiated on the information recording medium to form a spot of which diameter is S. The pitch P is defined to be bigger than the spot diameter S (P>S)

The spot diameter S can be calculated by λ/NA, wherein λ is a wavelength of the laser light, and NA is a numerical aperture of an objective lens not shown. In other words, the pitch P is designed to satisfy P>λ/NA.

The information recording medium 100 receives a recording light from the side of transparent layer 110, and the record mark is formed on both the land portion L0 and the groove portion G0 on the recording layer 120. After that, the information recording medium 100 receives a reproducing light from the side of transparent layer 110, and reflects a reflection light from the recording layer 120. A reproducing system not shown will receive the reflection light and retrieves the reproduced information.

The inventor has made a sample of the information recording medium 100 and has conducted recording and reproducing operation for the sample, and has found that the sample provides a remarkable cross-erase phenomenon.

The cross-erase phenomenon is that the information already recorded is erased when an additional information to be recorded in the contiguous portion is over-recorded. For example, when the information is recorded in the land portion L0, the information recorded in the adjacent groove portion G0 is erased. This could happen vice versa when the information is recorded in the groove portion G0 that the information previously recorded in the adjacent land portion L0 is erased. The cross-erase phenomenon damages the information recorded in the adjacent track. In this sense, when the storage density becomes higher, the loss of the information becomes considerably bigger.

In order to avoid the cross-erase phenomenon, the information could be recorded only in either track of the land portion L0 or the groove portion G0. However, recording in one track reduces recording capacity of the information recording medium and ruins the ability of high storage density for the information recording medium.

### SUMMARY OF THE INVENTION

Accordingly, in consideration of the above-mentioned problems of the related art, an object of the present invention is to provide an information recording medium including a substrate having a tiny pattern of serial groove portion and land portion alternately formed in parallel, a recording layer formed on the tiny pattern of the substrate, and a transparent layer formed on the ,recording layer, having the thickness of 0.05 to 0.4 mm, wherein the tiny pattern is formed under condition of P≦λ/NA that P is a pitch of the groove portion and the land portion, λ is a wavelength of a laser light for reproducing information from the information recording medium, NA is a numerical aperture of an objective lens for outputting the laser light for reproducing information from the information recording medium, and wherein a reference clock is recorded windingly in the land portion as a sine waveform.

Other object and further features of the present invention will be apparent from the following detailed description when lead-in conjunction with the accompanying drawings.

### BRIEF DESCRIPTION OF DRAWINGS

FIG. 1 is a cross-sectional view of an information recording medium according to a first embodiment of the present invention.

FIG. 2 is an enlarged plan view of the information recording medium according to the first embodiment of the present invention.

FIG. 3 is an enlarged plan view of the information recording medium according to a second and a third embodiment of the present invention.

FIG. 4 is an enlarged plan view of the information recording medium according to a fourth embodiment of the present invention.

FIG. 5 is an enlarged plan view of the information recording medium for CLV recording according to the fourth embodiment of the present invention.

FIG. 6 is an enlarged plan view of the information recording medium for CAV recording according to the fourth embodiment of the present invention.

FIG. 7 is a first example of dispersed recording of an address information.

FIG. 8 is a second example of dispersed recording of an address information.

FIG. 9 is a third example of dispersed recording of an address information.

FIG. 10 is a fourth example of dispersed recording of an address information.

FIG. 11 is a cross-sectional view of a fifth embodiment of the present invention.

FIG. 12 is a cross-sectional view of a sixth embodiment of the present invention.

FIG. 13 is a cross-sectional view of a seventh embodiment of the present invention.

FIG. 14 is a cross-sectional view of an information recording medium of land-groove type according to the related art.

FIG. 15 is an enlarged plan view of the information recording medium shown in FIG. 14 according to the related art.

### DETAILED DESCRIPTION OF THE PREFERRED EMBODIMENTS

### First Embodiment

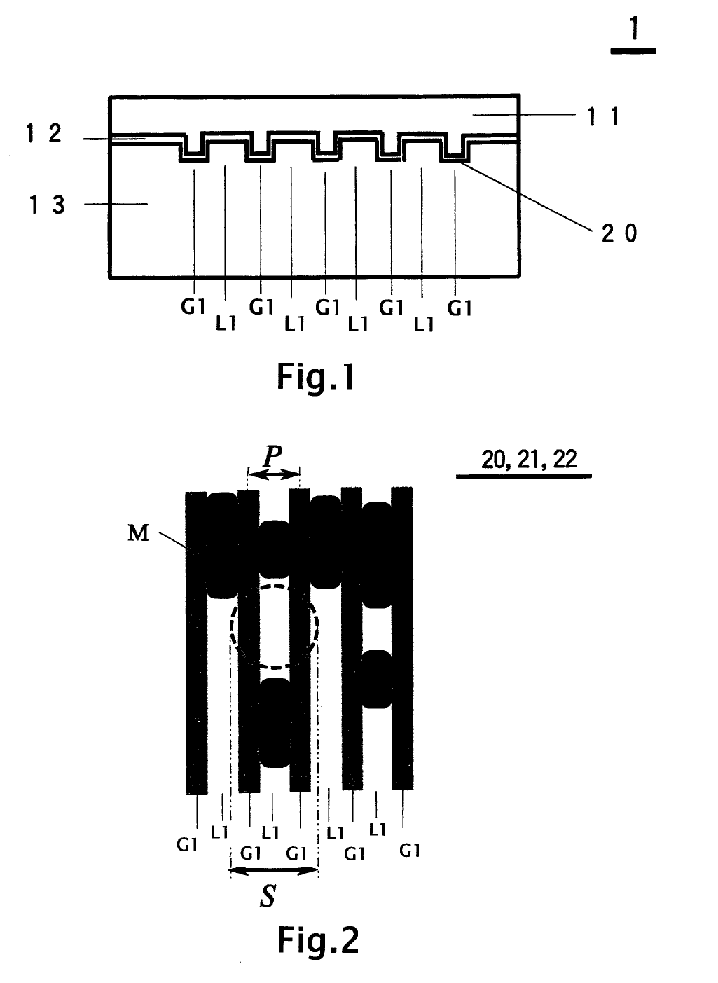

FIG. 1 is a cross-sectional view of an information recording medium according to a first embodiment of the present invention. FIG. 2 is an enlarged partial plan view of the information recording medium from upper side.

In FIG. 1, an information recording medium 1 is composed of, at least, a recording layer 12 and a transparent layer 11 serially laminated on a substrate 13 having a tiny pattern 20 in a concave-convex shape. The tiny pattern 20 is formed in a shape of serial parallel grooves with a concave groove portion G1 and a convex land portion L1. The information recording medium may have a disciform shape, a card shape or may be a tape. It may be a round shape, a rectangular shape or an elliptical shape. It may also have a hole. A laser light not shown for reproducing or recording is radiated from the other side of transparent layer 11 contacting with the recording layer 12.

The substrate 13 is a base for retaining the recording layer 12 and the transparent layer 11. The material for the substrate 13 is selected from any one of synthetic resin, ceramic and metal alloy. For example of synthetic resin, various types of thermoplastic resin such as polycarbonate, polymethyle methadrylate, polystyrene, polycarbonate polystyrene copolymer, polyvinyl chloride, alicyclic polyolefin, and polymethyle pentene can be used. A thermosetting resin or various types of energy ray curable resins (including ultra-violet curable resin, visible ray curable resin, or electron beam curable resin) can also be used. Such the synthetic resin can be mixed with metal powder or ceramic powder.

For example of ceramic supporting member, soda lime glass, soda aluminosilicate glass, borosilicate glass and crystal can be used. A metal substance having non-transmittancy such as aluminum can also be used. The substrate 13 should have thickness of 0.3 mm to 3 mm, preferably 0.5 mm to 2 mm for mechanical strength. In case the information recording medium 1 has disciform shape for compatible use with the conventional optical disc, the total thickness including the substrate 13, the recording layer 12, and the transparent layer 11 should be 1.2 mm.

The recording layer 12 is a film layer for recording and reproducing information. In the recording layer 12, information is recorded in either land portion L1 or groove portion G1. As for material of recording layer 12, any one of phase change substance, magneto-optical substance and dye substance is used. The phase change substance makes change of reflection and/or refraction, the malgneto-optical substance makes change of Kerr rotation angle, and the dye substance makes refraction change and/or depth change of the recording layer 12 upon recording.

Specifically, the material for phase-change recording medium can be selected from indium, antimony, tellurium, selenium, germanium, bismuth, vanadium, gallium, platinum, gold, silver, copper, aluminum, silicon, palladium, tin, or arsenic based alloy. The alloy includes oxide, nitride, carbide, sulfide, or fluoride. The alloy of GeSbTe, AgInTeSb, CuAlSbTe, and AgAlSbITe are preferable. The alloy can include at least one or more element selected from the group of Cu, Ba, Co, Cr, Ni, Pt, Si, Sr, Au, Cd, Li, Mo, Mn, Zn, Fe, Pb, Na, Cs, Ga, Pd, Bi, Sn, Ti, V, Ge, Se, S, As, Tl, In, and Pd for 0.01 atom % or more and less than 10 atom %. For examples of the composition of GeSbTe substance are Ge₂Sb₂Te₅, Ge₁Sb₂Te₄, Ge₈Sb₆₉Te₂₃, Ge₈Sb₇₁Te₂₄, GeSb₇₆,Te₁₉ Ge₁₀Sb ₆₈Te₂₂ and Ge₁₀Sb₇₂Te₁₈. For examples of the composition of GeSbTe substance admixed with Sn and In metal, and for examples of the composition of AgInSbTe substance are Ag₄In₄Sb₆₆Te₂₆, Ag₄In₄Sb₆₄Te₂₈, Ag₂In₆Sb₆₄Te₂₆, Ag₃In₅Sb₆₄Te₂₈, and Ag₂In₆Sb₆₆Te₂₆. For examples of the composition of AgInSbTe admixed with Cu, Fe and Ge metal or semi-conductor. In addition, there are also substance such as CuAlSbTe and AgAlSbTe.

Specific examples for magneto-optical material are terbium, cobalt, iron, gadolinium, chrome, neodymium, dysprosium, bismuth, palladium, samarium, holmium, praseodymium, manganese, titanium, erbium, ytterbium, lutetium and tin alloy. The alloy includes oxide, nitride, carbide, sulfide and fluoride. The alloy including transitional metals and rare-earth elements such as TbFeCo, GdFeCo, DyFeCo are preferable for magneto-optical material. The recording layer 12 can be composed of alternate laminating films of cobalt and platinum metal.

Specific examples of dye material are cyanine dye, phthalocyanine dye, naphthalocyanine dye, azo dye, naphthoquinone dye, fulgide dye, polymethune dye, acridine dye and porphyrin dye.

The recording layer 12 can be formed by either vapor film deposition or liquid film deposition. For example of the vapor film deposition, there are vacuum deposition of resistive heating type or electron beam type, direct current sputtering, high frequency sputtering, reactivity sputtering, ion beam sputtering, ion plating and CVD. For example of the liquid phase film forming method, there are spin coat or maceration.

The transparent layer 11 condenses reproducing light to lead it to the recording layer 12 under condition of low optical distortion. The material preferable for the transparent layer 11 has transmittance of more than or equal to 70% for reproducing wavelength λ, desirably 80%. The transparent layer 11 needs to have less optical anisotropy to suppress deterioration of reproducing light. Specifically, the transparent layer 11 has a birefringence of vertical incident light for ±100 nm or less, desirably ±50 nm or less. For the material of synthetic resin having such characteristic, there are polycarbonate, polymethyle methacrylate, cellulose triacetate, cellulose diacetate, polystyrene, copolymer of polycarbonate and polystyrene, polyvinyl chloride, alicyclic polyolefin, or polymethyle pentene, which can be used for the transparent layer 11.

The transparent layer 11 may have protective functionality for the recording layer 12 mechanically and chemically. A material having high rigidity can be used for this. For example, there are transparent ceramic (such as soda lime glass, soda aluminosilicate glass, borosilicate glass or crystal) or thermosetting resin, energy ray curable resin (such as ultra-violet curable resin, visible ray curable resin or electron beam curable resin). The thickness of the transparent layer 11 should be 0.4 mm or less in view of suppressing astigmatism when the information recording medium 1 inclines, and it should be 0.05 mm or more to prevent a scratch on the surface of the recording layer 12. That is in the range of 0.05 mm to 0.4 mm (more preferably within the range of 0.06 mm to 0.12 mm). Considering that the objective lens having high numerical aperture (NA), the scattering of the thickness is preferably ±0.003 mm or less. If the objective lens has NA of 0.85 or more, the roughness of the thickness should be ±0.002 mm or less, and if the objective lens is having 0.9 NA or more, the scattering of the thickness should be ±0.001 mm or less.

As explained above, the tiny pattern 20 has serially paralleled grooves that the pattern can be formed linearly, concentrically, or spirally. In FIG. 2, the tiny pattern 20 is formed in a convex shape of land portion L1 and a concave shape of groove portion G1 alternately and parallel. The concave shape in FIG. 1 corresponds to the groove portion G1 in FIG. 2 and the convex shape in FIG. 1 corresponds to the land portion L1 in FIG. 2.

The groove portion G1 is defined as a concave groove formed spirally or in concentric on the surface of the substrate to constitute a recording track thereon. The land portion L1 is defined as a convex groove formed spirally or in concentric on the surface of the substrate to constitute a recording track thereon. The substance indicated above corresponds to the substrate 13.

The distance between one groove to next groove (as well as one land to next land) is defined as pitch P. A spot diameter of reproducing laser light (beam) is defined as S. The relation between the pitch P and the spot is P≦S. As the spot S can be represented by λ/NA, wherein λ is a wavelength of the reproducing laser light land NA is a numerical aperture, the pitch P satisfies P≦λ/NA. The reproducing laser of violaceous laser provides the wavelength λ in the range of 350 nm to 450 nm, and high numerical aperture lens provides the NA in the range of 0.75 to 0.9, so that the pitch P is defined as 250 to 600 nm. If the information to be recorded is 2 hours of HDTV (High Definition Television) picture (digital) , the pitch is preferably in the range of 250 nm to 450 nm.

In FIG. 2, the record mark M is a data portion recorded in the recording layer 12 formed by change of reflection or refraction or Kerr effect of the substance for the recording layer 12 in accordance with the recording light radiated from the laser not shown.

Supposing the numerical aperture (NA) is in the range of 0.85 to 0.9, then the pitch P is preferably 250 nm to 400 nm. If the wavelength λ is 350 to 410 nm, then the pitch P is preferably 250 nm to 360 nm. In this case, the groove depth should be in the range of λ/8 n to λ/20 n, wherein “n” is a refractive index of transparent layer 11 for the light wavelength λ.

Especially, the refractive index for recording layer 12 decreases by the existence of the tiny pattern 20 that the depth of the groove portion G1 is desirably shallow. As to the limit of not deteriorate a jitter component of the reproducing signal, the groove depth should be λ/10 n or less. An output of push-pull signal for tracking the land portion L1 or groove portion G1 increases as the depth of the groove portion G1 becomes deeper. In this sense, the groove depth should be λ/18 n or more, which in other words, the groove depth is preferably in the range of λ/10 n to λ/18 n.

As described above, the information recording medium 1 is recorded with information in either groove portion G1 or land portion L1 so that the cross-erase can be suppressed. Further, as the relation between the pitch P and the spot diameter S is defined as P≦S, diminution of recording density can be suppressed.

The information recording medium 1 is evaluated in comparison with the conventional information recording medium 100. The evaluation is conducted by using a phase change material for the recording layer 12, measuring an output of a second track, recording a signal having different frequency than the recording signal for the second track on a first and a third tracks for 10 times respectively, and then measuring the output of the second track.

The amount of cross-erase is defined to be the difference of the output of the second track. The cross-erase of the conventional information recording medium 100 is −5 dB at maximum. As to the result of evaluation, the cross-erase of the information recording medium 1 is suppressed to −2 dB. In this sense, the cross-erase of the information recording medium 1 has been improved for 3 dB.

The information recording medium having a photo-magnetic material for the recording layer 12 is evaluated in the same way as described above. The cross-erase of the information recording medium 1 has been improved for 4 dB.

The information recording medium having a dye material for the recording layer 12 has been evaluated in the same way as described above. The cross-erase of the information recording medium 1 has been improved for 12 dB.

The present invention provides the information recording medium 1 recorded with information in either groove portion G1 or land portion L1 of the recording layer 12. The information recording medium 1 has been evaluated to find that it is preferable to record information in the land portion L1 rather than the groove portion G1 in view of reproducing information. This is considered that the land portion L1 is closer to the transparent layer 11 than the groove portion G1 that the area of the land portion has less heat flow of the recording layer 12 as the recording/reproducing light radiates to the recording layer 12 from the side of transparent layer 11.

As described above, the first embodiment of the present invention provides the information recording medium having the tiny pattern 20 defined as P≦λ/NA, wherein P is a pitch between the land portions L1 and the groove portions G1, λ is a wavelength of the laser, and NA is a numerical aperture of the objective lens so that the cross-erase of recorded information can be suppressed and the information can be recorded in high density.

In addition, as described above, the first embodiment of the present invention provides the information recording medium for selectively recording information in the land portion, so that the error rate can be less and re-writing characteristic can be improved.

### Second Embodiment

A second embodiment of the present invention provides the information recording medium having an address information for recording. The recording information medium is expected to record information in the predetermined place precisely. As in the case that the information recording medium is having the groove portion G1 and the land portion L1 alternately, as shown in FIG. 2, a recording position can only be detected relatively by the recording and/or reproducing apparatus not shown, which is not precise. Accordingly, an address information is needed in the tiny pattern 20. For example of conventional optical disk, an alternate construction of the land portion and the groove portion is arranged to have a flat surface for certain distance (for example, certain millimeter distance) that a pit having a plurality of lengths is allocated therein. The combination of the plurality of pits becomes the address information. This is an easy way to read-out the pit because it detects the change of the depth as a change of phase like a CD (Compact Disc). However, the flat surface for the address pit may reduce the recording capacity of the information recording medium. To ensure precise read-out operation, the flat surface may reduce approximately 10% of the recording capacity, which is not acceptable.

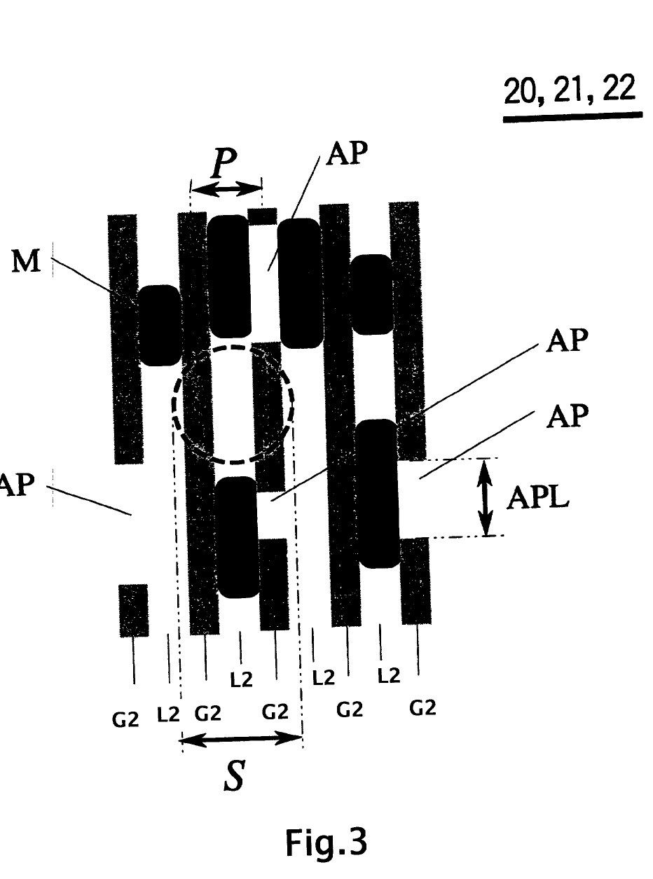

Accordingly, the second embodiment of the present invention provides a method for embedding an address information for the land portion of the information recording medium. FIG. 3 is a plan view of the construction of the tiny pattern of the information recording medium according to the present invention. In FIG. 3, a tiny pattern 21 is formed in a convex shape of land portion L2 and a concave shape of groove portion G2 alternately parallel. The tiny pattern 21 has an address pit AP formed by cutting off the groove portion G2. The address pit AP is dispersed in the entire information recording medium. The length of the address pit is shown as APL, and it can be constant or variable.

In case that the address pit has variable length, the address information is recorded by treating a code as a length information. The embedded address information can be detected by push-pull reproducing by dual element photo-detector or quadrant photo-detector commonly known. In FIG. 3, the information is recorded on the land portion L2 that the groove portion G2 becomes off-center from the spot. In this sense, the address pit AP can be detected by obtaining the difference of out-put of each side of the spot. The relative position of the address pit AP for the land portion L is predetermined that, in case that the information recording medium is disciform, the address pit can be formed in either outer or inner peripheral of the land portion L2.

The information recording medium 1 is recorded with a record mark M having various lengths. The record mark M is a data portion recorded by laser light not shown radiated on the recording layer to change the reflection and/or refraction of the substance of the recording layer. The record mark M can be formed contiguous to the address pit AP, which may cause a cross-talk upon reading out the mark M in certain statistic. In case the address pit length APL is variable, the amount of cross-talk becomes variable that the jitter component of record mark M increases and an error rate deteriorates. In this sense, the recording density should be decreased if the address pit length APL is variable.

### Third Embodiment

A third embodiment of the present invention provides an information recording medium having a constant address pit length APL. An address pit AP has constant length and is dispersed in the information recording medium 1. An address information is recorded in accordance with a predetermined table rules. For example, the address pit can be formed at every even interval and the address information is recorded in accordance with the presence of the address pit AP at each interval. Like mark position recording, the address information can be recorded by changing distance between each address pit AP. Then the data having a plurality of lengths can be recorded. The effectiveness of constant length for the address pit is that the cross-talk can be suppressed to minimum level, and that the deterioration of the recording density can be prevented.

The third embodiment of the present invention also provides an appropriate length for suppressing cross-talk of the information recording medium to the minimum level. The inventor of the present invention focus on the address pit length APL, and as a result of the study, the inventor finds that the recording density is not necessarily deteriorate if the address pit length APL is less than the reproducing spot diameter S. In other words, the address information can be embedded in the information recording medium without changing the conventional recording and reproducing system if the wavelength λ of the laser light, the numerical aperture NA and the address pit length APL are all designed to provide the address pit length APL being shorter than the reproducing spot diameter S.

As described above, the present invention provides the information recording medium 1 designed to have the relation of pitch P less than or equal to the reproducing spot diameter S (P≦S) and to be recorded in the land portion L1, so that the cross-talk can be suppressed. There also provided the information recording medium of which recording density is suppressed from deterioration by cutting the groove portion G1 and forming an independent address pit AP having limited length. There also provided the information recording medium 1 having the address pit length APL less than the reproducing spot diameter S (APL<S) so that the address pit AP can be embedded with suppressing the cross-talk at the minimum level without deteriorating the recording density.

### Fourth Embodiment

The basic structure of the information recording medium 1 is shown in FIGS. 2 and 3 as a preferable embodiment but it is not limited to FIGS. 2 and 3. Taking a broad view, the groove portions, the land portions, and the groove portion G and the land portion L are parallel to each other, respectively. However, it can also wobble its way in microscopic.

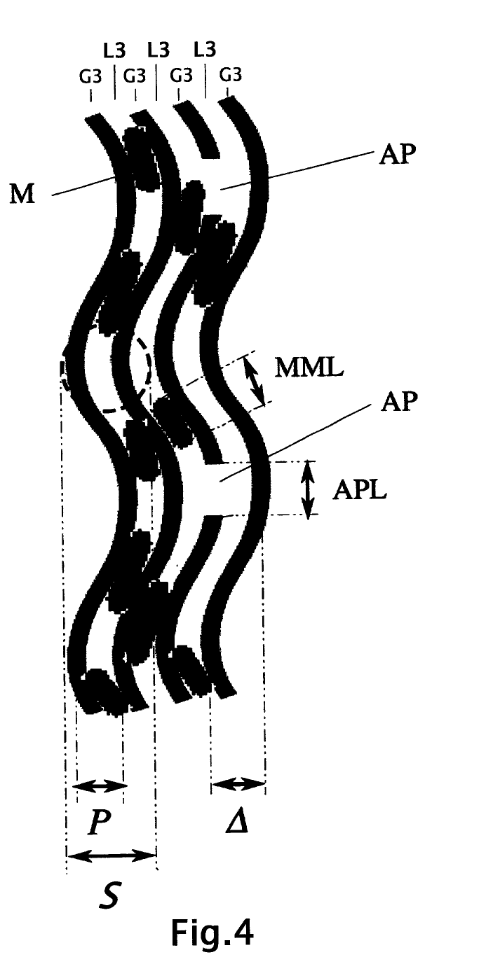

FIG. 4 is an enlarged view of the information recording medium in accordance with a fourth embodiment of the present invention. In FIG. 4, a land portion L3 and a groove portion G3 are winding in predetermined width 4 (in a peak to peak value). The distance between one groove portion to the next groove portion is constant that it is indicated by pitch P (the distance between one land portion to the next land portion is also constant pitch P). A laser not shown radiates a light having a spot diameter S on the recording layer. An address pit AP is formed on the land portion L3 with predetermined length of address pit length APL. A record mark M of data portion is recorded in the land portion by making phase-change of the substance of the recording layer (a change of reflection and/or refraction of the recording layer) with predetermined length MML.

In reproducing operation, a push-pull signal is detected so that a sine wave can be obtained to extract a clock corresponding to the frequency of the sine wave. The winding of the groove/land portion is in the range where the pitch P is bigger than the width Δ (Δ<P), so that an adjacent tracks do not physically contact. Consequently, the out-put fluctuation of the wobbling frequency upon reproducing operation can be suppressed.

Specifically, if the phase-change material is selected for recording layer 12, and the recording is conducted by utilizing the difference of reflection coefficient, the clock signal can be extracted when Δ<P and further 0.1S≦Δ, even if the physical condition of the recording layer has low reflection coefficient (such as amorphous state). However, if Δ is bigger than 0.1S, the adjacent tracks are influenced by the cross-talk that a flicker towards the time axial on a sinusoidal signal occurs. The clock signal can be extracted but the stability degrades. Accordingly, the winding width Δ should be in the relation of Δ<P, and 0.01S≦Δ≦0.1S.

If the information recording medium 1 has disciform shape, the winding is formed in constant linear velocity (CLV) or constant angular velocity (CAV). In case that the information recording medium 1 is recorded with information in CLV, the whole area of the disk is maintained in the same (constant) liner velocity. The winding groove portion G and land portion L hardly becomes parallel. However, as described above, if the recording is conducted on the land portion L of the recording layer 12, the clock signal should be extracted from the land portion L that the sine wave is recorded on the land portion L. Accordingly, each side of the land portion L should be parallel with each other.

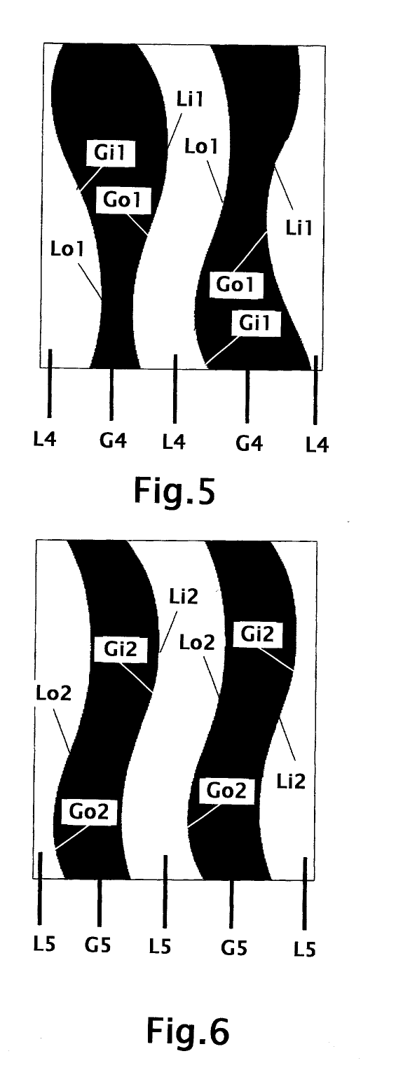

FIG. 5 is an enlarged plan view of the information recording medium 1 in accordance with the fourth embodiment of the present invention. In FIG. 5, a land portion L4 has an inner peripheral side wall Li1, and an outer peripheral side wall Lo1, and a groove portion G4 has an inner peripheral side wall Gi1, and an outer peripheral side wall Go1. The side wall Li1 and the side wall Go1 are the same, and the side wall Lo1 and the side wall Gi1 are the same.

The clock signal is recorded as a sinusoidal signal along the land portion L4 with CLV, the three land portions shown in FIG. 5 hardly become parallel with each other. However, in order to extract sinusoidal signal from the side walls without the impact of phase difference of the side walls, the inner peripheral side wall Li1 and the outer peripheral side wall Lo1 should be in parallel with each other. In the contrary, however, the inner peripheral side wall Gi1 and the outer peripheral side wall Go1 does not become parallel with each other.

In case that the information recording medium 1 is recorded with information in CAV, the whole area of the disk is maintained in the same (constant) angle velocity. The winding groove portion and land portion becomes parallel that the cross-talk of the adjacent tracks becomes constant. As a result, the fluctuation of the winding frequency can be suppressed to a minimum level for perfect reproducing operation.

FIG. 6 is an enlarged plan view of the information recording medium 1 recorded with information in CAV. As shown in FIG. 6, a land portion L5 and a groove portion G5 become parallel with each other. The land portion L5 has an inner peripheral side wall Li2, and an outer peripheral side wall Lo2, and the groove portion G5 has an inner peripheral side wall Gi2, and an outer peripheral side wall Go2. The side wall Li2 and the side wall Go2 are the same, and the side wall Lo2 and the side wall Gi2 are the same. As the information is recorded in the land portion L5, the clock signal needs to be extracted therefrom so that the clock signal is recorded therein. The clock signal is recorded in CAV so that, as shown in FIG. 6, the three land portions become parallel with each other. The groove portions also become parallel with each other. The inner peripheral side wall and the outer peripheral side wall of the land portion should be in parallel with each other to extract clock signal properly. In CAV recording, the inner and outer peripheral side walls of the groove portion also become parallel with each other.

In this sense, whether it is CLV recording or CAV recording, the inner and outer peripheral side walls of the land portion L should be in parallel with each other. Especially, in CAV recording, in addition to the land portion, the inner and outer peripheral side walls of the groove portion also become parallel with each other.

In CAV recording, the whole disk can be recorded with constant angle velocity. However, the disk may be separated into different zone that each zone may be recorded with information in different angle velocity, wherein the inside of each zone should be recorded with information with constant angle velocity.

The address information is embedded in the address pit AP but it can also be recorded in the side walls of the land portion L by amplitude modulation (AM), frequency modulation (FM) or phase modulation (PM) for the purpose of supplementing the address pit AP. Specifically, in AM, the presence of sine wave represents “1” and “0” of the address information. In FM, two sine waves having different frequency are formed and the difference of the frequency represents “1” and “0” of the address information. In PM, two sine waves having different phase angle are formed and the difference of the angles represents “1” and “0” of the address information. These signal waves are recorded on the side walls of the land portion.

Recording modulated address information on the side walls partially cuts the clock signal for reference clock recorded in sine wave. However, the modulation can record the address information efficiently that the cut off distance or time can be suppressed for a short period. The address information recorded on the side walls by modulation can be detected by push-pull signal as well as the clock signal of sine wave. Accordingly, each side wall of the land portion L should be parallel to each other to record the address information modulated by AM, FM or PM for the same reason described for recording clock signal above.

The sine wave for the reference clock can be recorded by adding to the address information recorded by these modulations. In this case, the clock signal is not interrupted, so that a stable clock signal can be extracted. Of course, the sine wave for clock signal and the modulated address information should be separated by a band-pass filter to decode each signal.

The modulation is not necessarily one format that it may adopt two or three different modulations for different areas formed in the disk. Two modulation formats can also be adopted in the same recording area.

The address information to be formed in the side wall of the address pit AP and the land portion L can be highly decomposed and dispersed on the disk. For example, the data can be recorded by utilizing dummy data “101” to combine “101X”, wherein X is either “1” or “0”, at constant intervals.

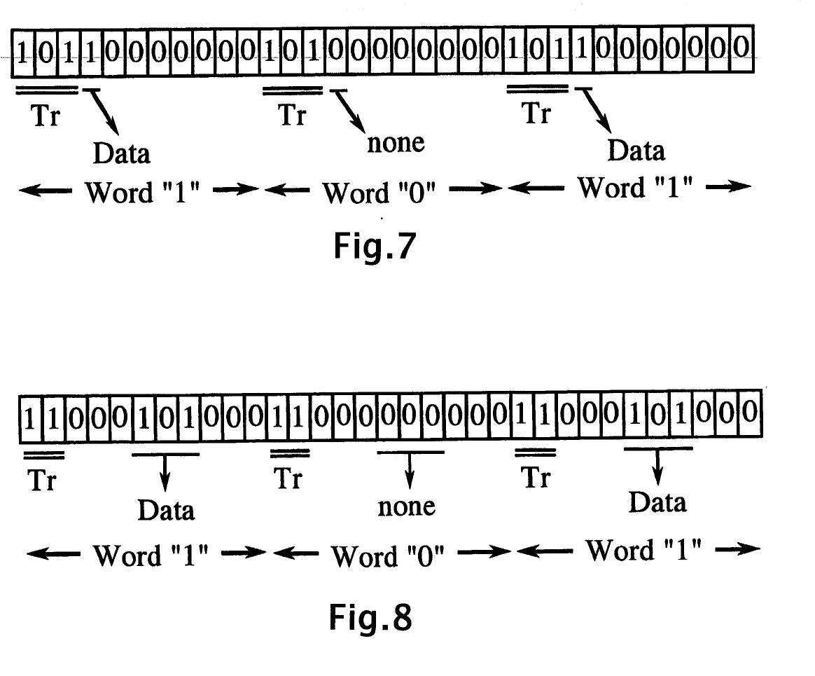

FIG. 7 is a first example of recording an address information dispersedly in the information recording medium. In FIG. 7, a data trigger Tr “101” is arranged in every constant interval. In this case, the interval is 11 bits and a data X is recorded subsequently to the data trigger Tr. In this sense, the data can be reconstructed by extracting the data X after the data trigger Tr. Suppose the data Xs are “1”, “0” and “1” respectively in FIG. 7, the original address information can be reconstructed as “101”. This recording method is useful when the data length can be read during the sufficient time. In this connection, the data to be extracted from one interval is defined as “word”.

FIG. 8 is a second example of recording an address information in the information recording medium. In FIG. 8, a data trigger Tr and a data can be separated for a predetermined intervals. The data trigger Tr “11” is arranged in every 11 bits. The data is recorded with or without presence of “101”. The data of 4^{th} to 6^{th} bits after the data trigger Tr is detected to reconstruct the data of 1 bit. This recording method can suppress read error because the data trigger Tr and the data is arranged separately. In this connection, the data to be extracted from one interval is defined as “word”.

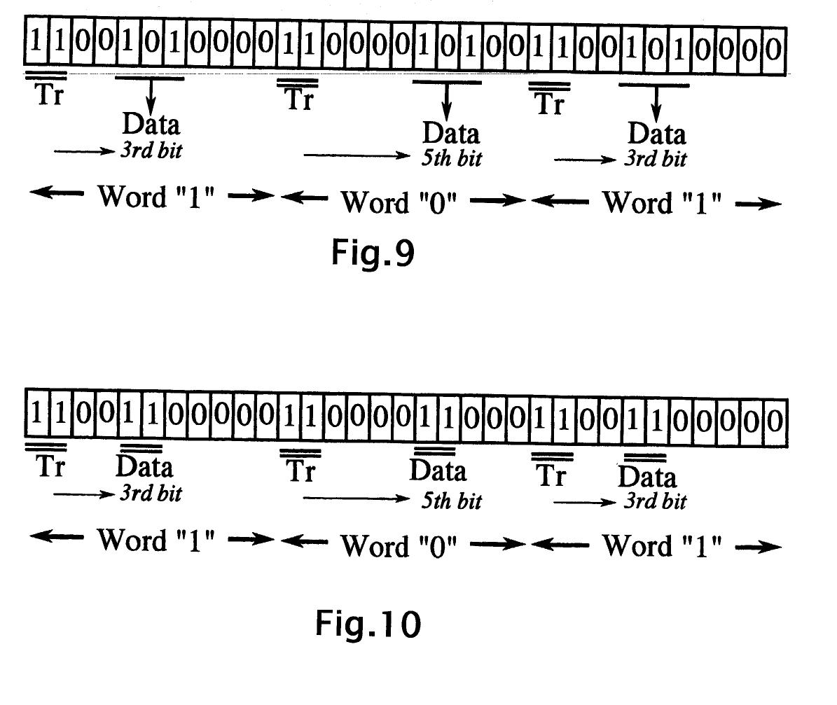

FIG. 9 is a third example of recording an address information in the information recording medium. In FIG. 9, a first data pattern (such as “11”) is arranged in every specific interval as a data trigger Tr, and a second data pattern (such as “101”) is arranged in between the first data patterns. The second data pattern is arranged in a position where predetermined bits after the first data pattern, in two ways of different position.

FIG. 9, the first data pattern has the data trigger Tr “11” arranged in predetermined interval (in this case, 11 bits) and the second data pattern “101” is arranged in between the first data patterns.

Then the second data pattern is also arranged in, for example, the third bit to the fifth bit and the fifth bit to the seventh bit after the data trigger Tr. Decoding operation is conducted by detecting which position of the data patterns the data is arranged. This recording method can evaluate reliability of whether the system detects the address information properly or not, and is useful for high reliability data recording and reproducing system.

The third example of recording the address information described above is utilizing two data patterns for dispersed recording. In this connection, if the recording system can provide high reliability of detecting information, then the first and second data patterns may have same patterns. The data pattern is recorded in constant time interval for extracting data pattern shorter than the time interval, and is decoded by measuring the time interval.

FIG. 10 is a fourth example of recording an address information in the information recording medium. In FIG. 10, the data trigger Tr (“11”) is recorded in every 11 bits as a first data pattern, then a second data pattern, which is the same “11” as the data trigger Tr, is recorded between the first data patterns. In this case, the recording position of the second data pattern is arranged for 3^{rd} bit to 5^{th} bit and 5^{th} bit to 7^{th} bit. The decoding information is conducted by detecting which recording pattern is the data recorded. In this case, the data pattern is arranged in 3rd bit, 5th bit and 3^{rd} bit after the data trigger Tr. As the data pattern is only one, the reproducing circuitry can be arranged more simple than reading two data patterns.

As described above, the highly dispersed recording of data information decompose the data in bit element for recording. Specifically, a dummy data of few bits for data trigger Tr is arranged in certain interval, and serial data sequence (such as “000 . . . ” or “111 . . . ”) is arranged in between the data triggers Tr. The address information is decomposed in bit element and converted into predetermined rule for recording, The bit in the predetermined position after the data trigger Tr is converted into predetermined rule for recording.

In reproducing procedure, all data recorded in the side walls of the address pit AP or the land portion L is reproduced. The data trigger Tr is detected by the data pattern. After excluding the data trigger Tr, one bit of the data is extracted. The address information is reproduced by accumulating single bit of the data extracted.

The address pit length APL for information recording using the address pit AP should be constant. Especially, the phase relation between the winding groove of sine wave and the address pit AP should be constant, so that the detection can be conducted easier. The phase relation can be set within the range of 0 to 360 degrees. For example, the address pit AP is applied in the position of 180 degrees from the sine wave winding groove. The reproduced push-pull signal can be obtained as the address pit signal protruded on the center of the sine wave signal. The signal can be extracted from the gate trigger formed contiguous to the 180 degrees phase of the clock signal created from the sine wave signal when the address pit signal occurs in the gate trigger signal.

The sine wave winding groove of the information recording medium preferably have the address pit AP in 90 degrees phase, as described in FIG. 4 so that the push-pull signal contains the address pit signal protruding on the sine wave signal. If the reproducing signal is sliced at the voltage bigger than the maximum level of the sine wave signal, the address pit signal can be obtained. If the gate trigger is used together, the more reliable address pit signal can be obtained.

The address information may have a lot of serial data sequence of “0” or “1”, which causes direct-current component. To prevent this, the data may be modulated by baseband modulation. The data sequence to be recorded in the address pit AP and in the side walls of the land portion L is exchanged into other code to make continuing “0”s or “1”s less than predetermined value. More specifically, there are the Manchester encoding (biphase modulation) method, PE modulation, MFM modulation, M2 modulation, NRZI modulation, NRZ modulation, RZ modulation and differential modulation for coding the data sequence. These coding and modulation methods can be used independently or in combination of some of them.

For example of the baseband modulation is the Manchester encoding method. This encoding method applies two bits as shown in table 1 below.

TABLE 1

| Before baseband | After baseband |
|---|---|
| modulation | modulation |
| 0 | 00, 11 |
| 1 | 01, 10 |

For example, two bits of “00” or “11” is applied when the data to be recorded is “0”, and two bits of “01” or “10” is applied when the data to be recorded is “1”. The data is always connected with inverted code of the previous code.

As a result, the address information, for example 100001 is converted into 010011001101 by the baseband modulation as shown in Table 2 below.

TABLE 2

| | |
|---|---|
| Before baseband | 100001 |
| modulation | |
| After baseband | 010011001101 |
| modulation | |

The address information before baseband modulation includes four serial “0”s and the appearance of “1” is twice as much as that of “1”. However, the data after baseband modulation includes only two serial “0” or “1” of which chance of appearance for “0” and “1” becomes even. The baseband modulation, which provides serial bit less than the predetermined value (in this case “two”) also provides an effectiveness of stable read-out operation of the data having long length of address information.

The address information to be recorded in the information recording medium can be selected from, for example, an absolute address applied in whole area of the information recording medium 1, a relative address applied for partial areas, a track number, a sector numbers a frame number, a field number, a time information, or an error correcting code. These data are indicated in the decimal or hexadecimal number system and are converted into binary information such as BCD code or gray code.

As for address pit recording or side wall modulation recording, even though it is a dispersed recording method, it can record relatively big amount of data, so that they can handle not only the address information but also other supplemental information. For example, the supplemental information may include, at least selected from, a type or a size of the information recording medium, its storage capacity, its recording linear density, its recording linear velocity, its track pitch, its recording strategy information, reproducing power, manufacturer information, manufacturing number, lot number, administration number, copyright related information, key information for encryption and decryption, encoded data, recording authorization code, recording refusal code, reproducing authorization code, and reproducing refusal code. Of course, the information above can be recorded with error correcting code for such the data.

The recording format of the address information may be involved with the signal format to be recorded in the recording layer 12. For example, the recording information is conducted to the land portion L of the recording layer 12, then a sync signal to be recorded in the land portion L and the address pit AP can be recorded in the same position that they are applied in the parallel position. The sync signal is recorded in predetermined time internal that if the address pit AP is synchronized with the sync signal, it can be recorded in very accurate position. As described above, the address pit AP tends to interfere with the recording signal. If a unique code is applied for a sync signal, the error caused by interference may be decreased. The unique code indicated above means a code, which does not appear in a predetermined modulation table. If the modulation format is, for example, the EFM plus method for recording signal in the recording layer 12, the data can be;

0001001001000100 0000000000010001.

The present invention is not limited to the first to fourth embodiment as described above that there may be various changes or applications for the invention. The construction element in the embodiments can be substitute with the other embodiments. In this connection, FIG. 1 shows basic structure of the information recording medium 1 but it is not limited to such the structure.

### Fifth Embodiment

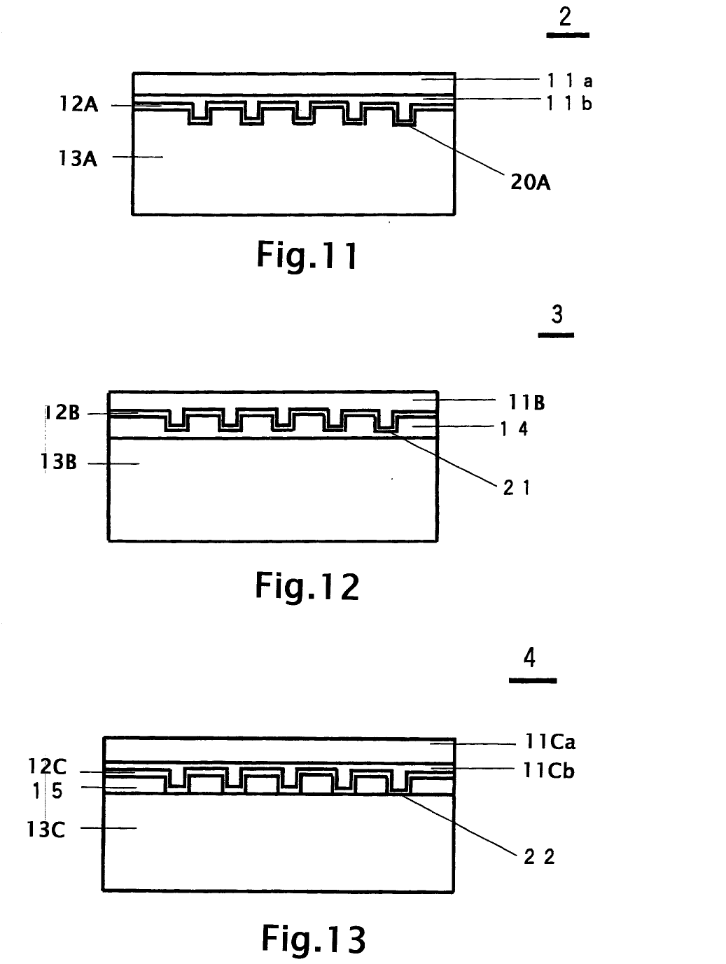

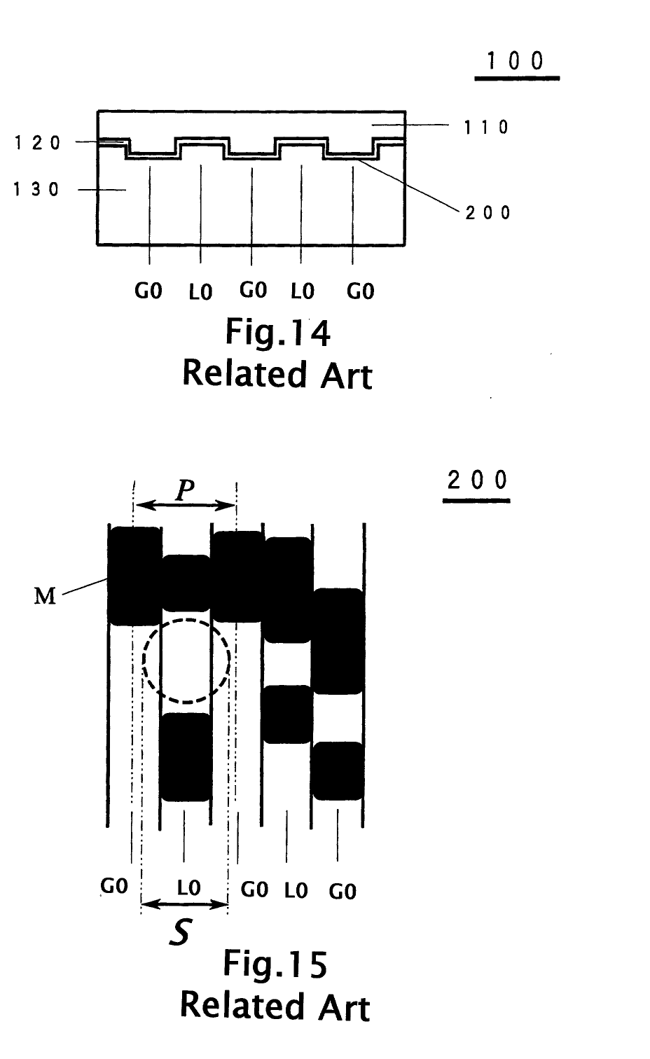

FIG. 11 is a cross-sectional view of an information recording medium in accordance with a fifth embodiment of the present invention. In FIG. 11, an information recording medium 2 is composed of a transparent layer 11a, an adhesive transparent layer 11b, a recording layer 12A, a substrate 13A, and a tiny pattern 20A formed on the substrate 13A. The recording layer 12A, the substrate 13A and the tiny pattern 20A can be the same as the recording layer 12, the substrate 13 and the tiny pattern 20 shown in FIG. 1 respectively.

The adhesive transparent layer 11b sticks the recording layer 12A and the transparent layer 11a together, and passes 70%, preferably 80% of the light having a wavelength λ. As to the material of the adhesive transparent layer 11b, a thermosetting resin, id an energy ray curable resin including ultraviolet, visible light and electron beam curable resins, a wet curable resin, a combined liquid curable resin, and a thermoplastic resin containing solvent having adherent can be used.

The thickness of the adherent transparent layer 11b should be more than or equal to 0.001 mm to provide an adherence, and should be less than or equal to 0.04 mm considering the stress on the adherent material. Desirably, more than or equal to 0.001 mm and less than or equal to 0.03 mm. Considering the camber of the information recording medium 2, the thickness of the adhesive transparent layer 11b is most preferable in the range of 0.001 mm or more and 0.01 mm or less.

### Sixth Embodiment

FIG. 12 is a cross-sectional view of an information recording medium in accordance with a sixth embodiment of the present invention. In FIG. 12, an information recording medium 3 is composed of a transparent layer 11B, a recording layer 12B, a substrate 13B, a tiny pattern 21 formed on the substrate 13B, and a resin layer 14. The resin layer 14 has the tiny pattern 21 and a flat surface in each front and rear surface respectively, wherein the flat rear surface contacts with the substrate 13B. The resin layer 14 can be made of a thermosetting resin, an energy ray curable resin including ultraviolet ray, visible light and electron beam curable resins, a wet curable resin, a combined liquid curable resin, and a thermoplastic resin containing solvent having adherent. A reproducing light does not reach to the resin layer 14, so that the transmittance of the resin layer is not limited. The thickness of the resin layer 14 should be 0.02 mm or less considering the camber of the information recording medium 3.

### Seventh Embodiment

FIG. 13 is a cross-sectional view of an information recording medium in accordance with a seventh embodiment of the present invention. In FIG. 13, an information recording medium 4 is composed of a transparent layer 11Ca, an adhesive transparent layer 11Cb, a recording layer 12C, a substrate 13C, a tiny pattern 22, and a pattern transferring layer 15. The pattern transferring layer 15 has the tiny pattern 21 and a flat surface in each front and rear surface respectively, wherein the rear surface contacts with the substrate 13C. The pattern transferring layer 15 can be made of a metal or a metal alloy (including oxide, nitride, carbide, sulfide, or fluoride) or a resin. The thickness of pattern transferring layer 15 is set within the range from 5 to 200 nm. The resin material can be selected from the group of Novolac photosensitive resin or a polyhydroxy styrene photosensitive resin, which is capable for alkali development.

Each element of the information recording mediums 1 to 4 can be substitute from each other as long as the reproducing characteristic does not deteriorates. For example, two information recording mediums selected from the four information recording mediums 1 to 4 can be stick together with each substrate to have double side. In addition, a pair of the transparent layer and the recording layer can be put on the transparent layer of the information recording medium to form bilayer construction. The bilayer information recording medium can double the recording capacity. There also can be three recording layers or more to form a multilayer information recording medium.

The recording layer described above has only one layer. However, the recording layer may have multilayer to improve recording characteristic and reproducing characteristic. For this purpose, the recording layer may have a supplemental layer of an metal alloy (including oxide, nitride, carbide, sulfide, or fluoride) of silicon, tantalum, zinc, magnesium, calcium, aluminum, chrome, zirconium, or high reflection coating (such as aluminum, gold, silver or heat sink material of metal alloy including at least one of them). As the recording layer is composed of phase change material, the transmittance of the recording layer is set to 12 to 24% with combination of the supplemental layer, so that the recording characteristic, reproducing characteristic, storage characteristic and reproducing characteristic can be improved.

The transparent layer 11 may have an anti-static layer, a lubricating layer or a hard coating layer not shown on the other side surface where it contacts with the recording layer 12. As to the material for the lubricating layer, a liquid lubricant arranged with silicon or fluorine in a carbon hydride molecule can be used. The thickness of the lubricating layer is preferably within the range of 0.1 nm to 10 nm.

As to the material for the hard coating layer, a thermosetting resin, an energy ray curable resin (such as ultra-violet curable resin, visible ray curable resin or electron beam curable resin), a wet curable resin, a combined liquid curable resin, or a thermoplastic resin containing solvent having a transmittance of 70% for the light having wave λ can be used.

The hard coating layer should provide more than predetermined value of scratching test value specified in, for example, JIS (Japan Industrial Standard) K5400 in consideration of wear and abrasion resistance. The hardest material for an objective lens of information reproducing system is a glass that the scratching test value is preferably more than “H” grade. If not, the hard coating layer may flake off and cause more error rate upon reproducing operation. The thickness of the hard coating layer is preferably 0.001 mm or more in consideration of the high-impact, and 0.01 mm or less in consideration of camber.

In this connection, a material having transmittance of 70% for light having wavelength A scratch test value of “H” such as carbon, molybdenum, and silicon may be used. These materials can be used as a single substance, or combination of an alloy including oxide, nitride, carbide, sulfide, or fluoride with layer thickness of 1 to 1000 nm.

The other side of the substrate 13 contacting with the recording layer 12 not shown may have a printing label. As for printing material, various energy ray curable resin such as ultra-violet curable resin, visible ray curable resin or electron beam curable resin including various pigment or dye can be used. The thickness of the printing label is preferably 0.001 mm or more in consideration of legible printing, and 0.05 mm or less in consideration of camber of the whole information recording medium.

The tiny patterns 20, 21, 22 of the groove portion and the land portion (hereinafter generally referred to as the groove portion G and land portion L respectively) are described to be flat but their cross-sectional view may be V-shaped or Λ-shaped.

The address pit AP is described to handle the address information or sub information and the side wall of the winding land portion L is described to handle the sine wave for the reference clock. However, the address pit AP may be arranged in predetermined interval to produce sine wave signal for the reference clock and the side wall of the land portion L may be recorded with the address information by utilizing any one of AM, FM and PM.

The address pit AP can be omitted that the address information is recorded in the side wall of the winding groove portion G or the winding land portion L by utilizing either recording format of AM, FM or PM. However, the reference clock may not be obtained properly by this. Accordingly, the reference clock and the address information is preferably recorded intermittently in the recording position of the reference clock.

The information recording medium 1 may have an area for reproducing only separate from the recording and reproducing area. This area for reproducing only may be formed with a pit or recorded in the winded groove by any one of recording format of AM, FM and PM, or formed by barcode. Such the area for reproducing only may contain an information for tuning the recording/reproducing apparatus, and handles information, for example, a separate recognition information, a copyright information, or a copy limitation information. The position of the area can be arranged optionally. However, if the information recording medium is disciform, the area may be positioned in the inner circumference of the medium and recording/reproducing area may be positioned in the outer circumference of the medium, so that the areas do not overlap with each other. Especially, the two areas are most preferably placed contiguously and contact with each other by one track for continuous reproducing.

The information recording medium may also have a hologram or legible tiny pattern for recognition separate from the area for recording. The information recording medium may be incorporated in a cartridge for easy loading in the recording/reproducing system or better protection of the surface thereof. The information recording medium may not be limited in size that it may have a diameter from 20 mm to 400 mm. Specifically, it may have a diameter of 32 mm, 41 mm, 51 mm, 60 mm, 65 mm, 80 mm, 88 mm, 120 mm, 130 mm, 200 mm, 300 mm, or 356 mm.

### Comparative Example 1

The inventor has studied an information recording medium having a diameter of 120 mm and a structure of the information recording medium 2. The reproducing system is assumed to have a laser of which wavelength λ is 405 nm, an objective lens of which numerical aperture (NA) is 0.75, and the spot diameter S is 540 nm. The substrate 13 has the tiny pattern 20A of which thickness is 1.1 mm and is made of polycarbonate resin. The recording layer 12A is multi-layer including one of phase-change material AgInSbTe with the thickness of 300 nm. Specifically, the multi-layer is built-up in the order of AgPdCu, ZnSSiO, AgInSbTe, and ZnSSiO layers towards the adhesive transparent layer 11b. The adhesive transparent layer 11b has a transmittance of 70% for the laser having light wave of 405 nm, and made of polyester-acrylate ultra-violet curable resin with 0.01 mm thickness. The transparent layer 11a has a transmittance of 80% and is made of polycarbonate material of which birefringence is ±50 nm or less in vertical (90 degrees) incident double pass, with 0.09 mm thickness. The total thickness of the substrate 13 through the transparent layer 11a is therefore, approximately 1.2 mm.

The tiny pattern 20A is formed as shown in FIG. 4 that the land portion L and the groove portion G will be parallel in microscopic. The pitch P is 370 nm. The land and groove portions are winding in sine wave to produce a clock signal and the winding width Δ is 10 nm. The address pit AP is embedded by cutting the groove portion G, and has the same height of land portion L. The address pit is has one single size of address pit length APL, which length will not exceed the spot diameter S.

The comparative example 1 hereof provides the study of the address pit length APL for 300 nm (sample 1), 400 nm (sample 2), 500 nm (sample 3) and 600 nm (comparative example 1).

Each information recording medium is recorded with information in the land portion L by phase-change recording, specifically utilizing the D8-15 modulation method (described in Japanese Patent Application Laid-open Publication No. 2000-286709). The signal having the length of 3T to 11T forms a record mark M that the shortest length of the mark length MML is 200 nm, which makes recording capacity of 20 GB for the recording area for the information recording medium having the diameter of 24 mm to 58 mm.

The information recording medium is reproduced by the reproducing apparatus described above, and the error rate of D8-15 modulation signal recorded in the land portion L is measured. The error rate becomes uncorrectable when it exceeds 3E-4, which is set for full limit.

The table 3 shows the result of the first comparison.

TABLE 3

| | λ | | | P | MML | APL | Δ | Error | |
|---|---|---|---|---|---|---|---|---|---|
| | (nm) | NA | S | (nm) | (nm) | (nm) | (nm) | Rate | Condition |
| Sample 1 | 405 | 0.75 | 540 | 370 | 200 | 300 | 10 | 3.1E-5 | OK |
| Sample 2 | 405 | 0.75 | 540 | 370 | 200 | 400 | 10 | 5.2E-5 | OK |
| Sample 3 | 405 | 0.75 | 540 | 370 | 200 | 500 | 10 | 2.0E-4 | OK |
| Comparative | 405 | 0.75 | 540 | 370 | 200 | 600 | 10 | 6.0E-4 | NG |
| Example 1 | | | | | | | | | |

The samples 1 to 3 all satisfy the following relation; P<S, MML<S, Δ<P, and APL<S. The error rate deteriorates as APL becomes bigger but they are all within a predetermined value. The comparative example 1 provides condition of “NG” but it also provides APL bigger than S which system does not exist.

### Comparative Example 2

The inventor has studied an information recording medium having a diameter of 120 mm and a structure of the information recording medium 2. The reproducing system is assumed to have the same condition as the first comparison except for an objective lens, which has a numerical aperture (NA) for 0.85, and the spot diameter S is 476 nm.

The substrate 13A with the tiny pattern 20A has 1.1 mm thickness and is made of polycarbonate resin. The recording layer 12A is multi-layer including one of phase-change material SbTeGe with the thickness of 200 nm. Specifically, the multi-layer is built-up in the order of AgPdCu, ZnSSiO, SbTeGe, and ZnSSiO layers towards the adhesive transparent layer 11b.

The adhesive transparent layer 11b has the same condition as that of the first comparison except for material of which is epoxy-acrylate, and has transmittance of 70% for the laser having light wave of 405 nm, and made of ultra-violet curable resin with 0.01 mm thickness. The transparent layer 11a has the same condition as that of the first comparison and the total thickness of the substrate 13 through the transparent layer 11a is therefore, approximately 1.2 mm.

The tiny pattern 20A is formed as shown in FIG. 4 that the land portion L and the groove portion G will be parallel in microscopic. The pitch P is 330 nm. The land and groove portions wobble in sine wave to produce a clock signal and the winding width Δ is 7.5 nm. The address pit AP is embedded by cutting the groove portion G, and has the same height of land portion L. The address pit is has one single size of address pit length APL, which length will not exceed the length of the spot diameter S.

The second comparison hereof provides the study of the address pit length APL for 370 nm (sample 4), 420 nm (sample 5), 470 nm (sample 6) and 520 nm (comparative example 2).

Each information recording medium is recorded with information in the land portion L by phase-change recording, specifically utilizing the D8-15 modulation method (described in Japanese Patent Application Laid-open Publication No. 2000-286709). The signal having the length of 3T to 11T forms a record mark M that the shortest length of the mark length MML is 178 nm, which makes recording capacity of 25 GB for the recording area for the information recording medium having the diameter of 24 mm to 58 mm.

The information recording medium is reproduced by the reproducing apparatus described above, and the error rate of D8-15 modulation signal recorded in the land portion L is measured. The error rate becomes uncorrectable when it exceeds 3E-4, which is set for full limit.

The table 4 shows the result of the second comparison.

TABLE 4

| | λ | | | P | MML | APL | Δ | Error | |
|---|---|---|---|---|---|---|---|---|---|
| | (nm) | NA | S | (nm) | (nm) | (nm) | (nm) | Rate | Condition |
| Sample 4 | 405 | 0.85 | 476 | 330 | 178 | 370 | 7.5 | 2.4E-5 | OK |
| Sample 5 | 405 | 0.85 | 476 | 330 | 178 | 420 | 7.5 | 5.6E-5 | OK |
| Sample 6 | 405 | 0.85 | 476 | 330 | 178 | 470 | 7.5 | 2.5E-4 | OK |
| Comparative | 405 | 0.85 | 476 | 330 | 178 | 520 | 7.5 | 5.6E-4 | NG |
| Example 2 | | | | | | | | | |

The samples 4 to 6 all satisfy the following relation; P<S, MML<S, Δ<P, and APL<S. The error rate deteriorates as APL becomes bigger but they are all within a predetermined value. The comparative example 2 provides condition of “NG” but it also provides APL bigger than S which system does not exist.

### Comparative Example 3

The inventor has studied an information recording medium having a diameter of 120 mm and a structure of the information recording medium 2. The reproducing system is assumed to have a laser of which wavelength A is 370 nm, an objective lens of which numerical aperture (NA) is 0.9, and the spot diameter of the reproducing laser light beam is 411 nm. The substrate 13 has the tiny pattern 20A with 1.1 mm thickness and is made of polymethyl-methacrylate resin. The recording layer 12 is multi-layer including one of phase-change material CuAlTeSb with the thickness of 110 nm. Specifically, the multi-layer is built-up in the order of AgPdCu, ZnSSiO, CuAlTeSb, and ZnSSiO layers towards the adhesive transparent layer 11b. The adhesive transparent layer 11b has a transmittance of 70% for the laser of which wavelength is 370 nm, and made of urethane-acrylate ultra-violet curable resin with 0.03 mm thickness. The transparent layer 11a has a transmittance of 80% and is made of polycarbonate material of which birefringence is ±50 nm or less in vertical (90 degrees) incident double pass, with 0.07 mm thickness. The total thickness of the substrate 13 through the transparent layer 11a is therefore, approximately 1.2 mm.

The tiny pattern 20A is formed as shown in FIG. 4 that the land portion L and the groove portion G will be parallel in microscopic. The pitch P is 280 nm. The land and groove portions are winding in sine wave to produce a clock signal and the winding width Δ is 7 nm. The address pit AP is embedded by cutting the groove portion G, and has the same height of land portion L. The address pit has one single size of address pit length APL, which length will not exceed the spot diameter S.

The third comparison hereof provides the study of the address pit length APL for 250 nm (sample 7), 350 nm (sample 8), 400 nm (sample 9) and 450 nm (comparative example 3).

Each information recording medium is recorded with information in the land portion L by phase change recording, specifically utilizing the EFM plus modulation method. The signal having the length of 3T to 11T forms a record mark M that the shortest length of the mark length MML is 152 nm, which makes recording capacity of 32 GB for the recording area for the information recording medium having the diameter of 24 mm to 58 mm.

The information recording medium is reproduced by the reproducing apparatus described above, and the error rate of EFM plus modulation signal recorded in the land portion L is measured. The error rate becomes uncorrectable when it exceeds 3E-4, which is set for full limit.

The table 5 shows the result of the third comparison.

TABLE 5

| | λ | | | P | MML | APL | Δ | Error | |
|---|---|---|---|---|---|---|---|---|---|
| | (nm) | NA | S | (nm) | (nm) | (nm) | (nm) | Rate | Condition |
| Sample 7 | 370 | 0.9 | 411 | 280 | 152 | 250 | 7 | 3.7E-5 | OK |
| Sample 8 | 370 | 0.9 | 411 | 280 | 152 | 350 | 7 | 8.0E-5 | OK |
| Sample 9 | 370 | 0.9 | 411 | 280 | 152 | 400 | 7 | 2.9E-4 | OK |
| Comparative | 370 | 0.9 | 411 | 280 | 152 | 450 | 7 | 7.5E-4 | NG |
| Example 3 | | | | | | | | | |

The samples 7 to 9 all satisfy the following relation; P<S, MML<S, Δ<P, and APL<S. The error rate deteriorates as APL becomes bigger but they are all within a predetermined value. The comparative example 3 provides condition of “NG” but it also provides APL bigger than S which system does not exist.

As described in the third comparison, the D8-15 modulation and EFM plus modulation methods are used but the modulation format is not limited to these that it may be a fixed length coding or a variable length coding. Additionally, (1,7) modulation, 17PP modulation, DRL modulation, (1,8) modulation or (1,9) modulation method of which shortest mark length is 2T may be used. For example of a fixed length coding of the (1,7) modulation method, Japanese Patent Application Laid-open Publication No. 2001-80205 discloses the D1,7 modulation method as a representative format. There are also the (1,7) modulation or (1,9) modulation method based on fixed length coding of the (D4,6) modulation method described in Japanese Patent Application Laid-open Publication No. 2000-332613, which can be used for coding method. The 17PP modulation method is a kind of variable length coding of the (1,7) modulation method and is described in Japanese Patent Application Laid-open Publication No. 11(1999)-346154. There are also modulation method using a shortest mark length of 3T such as EFM modulation, (2,7) modulation and (2,8) modulation methods, can be used. The modulation method using a shortest mark length of 4T such as the (3,17) modulation method, or using a shortest mark length of ST such as the (4,21) modulation method are also acceptable.

As described above, according to a first aspect of the present invention, there is provided the information recording medium having minute structure with the relation of P≦S, and recorded with information in the land portion L, so that the cross-erase phenomenon can be suppressed.

According to a second aspect of the present invention, there is provided the information recording medium of which groove portion is cut to embedded independent address pit AP, so that the recording capacity does not decrease.

According to a third aspect of the present invention, there is provided the information recording medium of which address pit length APL is constant, so that the cross-talk of the record mark M and the address pit AP can be suppressed to constant value.

According to a fourth aspect of the present invention, there is provided the information recording medium of which address pit length APL is smaller than the spot diameter S (APL<S), so that the cross-talk can be suppress to minimum level and that the address pit AP can be embedded without decreasing the recording capacity.

It is to be understood that the invention is not limited in its application to the details of construction and arrangement of parts illustrated in the accompanying drawings, since the invention is capable of other embodiments and of being practiced or carried out in various ways. Also it is to be understood that the phraseology or terminology employed herein is for the purpose of description and not of limitation.

What is claimed is:

1. An information recording medium comprising:
a substrate having a tiny pattern of serial groove portion and land portion alternately formed in parallel;
a recording layer formed on the tiny pattern of the substrate; and
a transparent layer formed on the recording layer, having the thickness of 0.05 to 0.4 mm, wherein the tiny pattern is formed under condition of P≦λ/NA that P is a pitch of the groove portion and the land portion, λ is a wavelength of a laser light for reproducing information from the information recording medium, NA is a numerical aperture of an objective lens for outputting the laser light for reproducing information from the information recording medium, and wherein a reference clock is recorded windingly in the land portion as a sine waveform.

2. An information recording medium comprising:
a substrate having a tiny pattern of serial groove portion and land portion alternately formed in parallel;
a recording layer formed on the tiny pattern of the substrate; and
a transparent layer formed on the recording layer, having the thickness of 0.05 to 0.4 mm, wherein the tiny pattern is formed under condition of P≦λ/NA that P is a pitch of the groove portion and the land portion, λ is a wavelength of a laser light for reproducing information from the information recording medium, NA is a numerical aperture of an objective lens for outputting the laser light for reproducing information from the information recording medium, and wherein an address pit having an-independent limited length and indicating recording position of data in conjunction with cutting off the groove portion is formed in the groove portion with the same height of the land portion.

3. The information recording medium as claimed in claim 2, wherein a reference clock is recorded windingly in the land portion as a sine waveform.
